(19) United States
(12) Patent Application Publication
(10) Pub. No.: US 2026/0213418 A1
(43) Pub. Date: Jul. 23, 2026

(54) HORN ANTENNA ASSEMBLY INTEGRATED WITH A CALIBRATION SIGNAL

(71) Applicant: VIETTEL GROUP, Hanoi City (VN)

(72) Inventors: THI HUONG NGO, Ha Noi City (VN); HUU HOANG BUI, Ha Noi City (VN); VAN PHU NGUYEN, Ha Noi City (VN); MINH DUC HOANG, Ha Noi City (VN); VAN LOI NGUYEN, Ha Noi City (VN)

(73) Assignee: VIETTEL GROUP, Hanoi City (VN)

(21) Appl. No.: 19/433,728

(22) Filed: Dec. 27, 2025

(30) Foreign Application Priority Data
Dec. 27, 2024 (VN) 1-2024-09781

(51) Int. Cl. H01Q 13/02

(52) U.S. Cl. CPC H01Q 13/0275

(57) ABSTRACT

A horn antenna assembly integrated with a calibration signal system is disclosed. The antenna assembly is operable across multiple frequency bands, including S, C, X, Ku, and Ka bands. The assembly is designed to be scalable into a two-dimensional horn antenna array by increasing the number of elements along both the E-plane and H-plane axes. The design principle is based on the combination of horn antenna elements and a stepped waveguide power divider, which enables the integration of a calibration waveguide. To broaden the antenna's bandwidth, each horn element incorporates symmetric metal ridges. Furthermore, the inclusion of a stepped adapter and fillets at the corners of the power divider enhances the voltage standing wave ratio (VSWR) performance of the antenna assembly.

### TECHNICAL FIELD

This invention provides a double-ridged horn antenna assembly with an integrated calibration signal, intended for two-dimensional electronically scanned phased array antennas. The assembly comprises four horn elements and a waveguide power divider integrated with a coupling waveguide. This horn antenna assembly is applied in high-resolution phased array radar systems, such as 3D air surveillance radars used in air defense.

### TECHNICAL BACKGROUND

The development of modern multi-functional radar systems increasingly requires the research and design of broadband antenna arrays capable of electronic beam steering in both horizontal and vertical directions, such as Active Electronically Scanned Arrays (AESA). To support wide-angle scanning, the radiating elements must meet stringent requirements for both operating bandwidth and radiation beamwidth. A critical factor in meeting these requirements is the ability to design and manufacture broadband antennas with a main beam that maintains a non-squint angle across the frequency band.

The most common types of antennas used in radar systems are waveguide slot antennas, reflector antennas and microstrip antennas. Each type has its own advantages and disadvantages, making them suitable for different system design requirements. Table 1 presents a comparison of the main parameters of these antenna types with those of a horn antenna array.

TABLE 1
Comparison of parameters of different antenna types

| | Slotted | | | |
|---|---|---|---|---|
| | waveguide | | Microstrip | Horn |
| | antenna | Reflector | antenna | antenna |
| Basic Parameters | array | antenna | array | array |
| Bandwidth | Wide | Wide | Narrow | Wide |
| Transmission loss | Low | Low | High | Low |
| Main Beam Squint | Yes | No | No | No |
| Angle | | | | |
| Electronic Beam | Limited | Limited | Good | Good |
| Scanning | | | | |

From Table 1, it can be seen that the horn antenna array technology has suitable parameters for application in high-resolution, broadband radar systems, specifically as follows:
+ Wide bandwidth (≥500 MHz);
+ Low transmission loss;
+No main beam squint angle when changing operating frequency;
+ Capable of two-dimensional electronic beam scanning.

Therefore, horn antenna array is chosen for high-resolution radar generations with two-dimensional electronically scanned phased arrays (AESA).

Furthermore, in two-dimensional electronically scanned AESA antenna systems, the transmit/receive modules (TRMs) directly control the phase and amplitude of each antenna element. Hence, monitoring the phase and amplitude of each radiating element within the system plays a critical role and significantly impacts the radar's target detection accuracy. Consequently, the horn antenna array assembly integrated with calibration signals meets the requirements of antennas used in high-resolution radar systems.

Therefore, the horn antenna array is chosen for high-resolution radar systems employing two-dimensional electronically scanned phased arrays (AESA).

Furthermore, in such two-dimensional AESA systems, the transmit/receive modules (TRMs) directly control the phase and amplitude of each antenna element. Consequently, monitoring the phase and amplitude of each radiating element within the system is critical and has a significant impact on the radar's target detection accuracy. As a result, horn antenna arrays integrated with calibration signals effectively meet the stringent requirements of antennas used in high-resolution radar applications.

### Technical Essence of the Invention

The purpose of the invention is to provide an horn antenna assembly integrated with a calibration signal. The assembly consists of 2^{N} horn elements and a 2^{N}-port waveguide power divider with a step-down structure to integrate a coupling waveguide for monitoring the phase and amplitude of each antenna element.

To achieve the above purpose, the horn antenna assembly comprises the following main components:

The horn antenna element comprises two symmetrical metal ridges in the E-plane that help broaden the antenna's operational bandwidth by gradually transforming the impedance from the waveguide to free space. These symmetrical ridges have a triangular shape and extend from the interior of the horn antenna to its aperture.

The equal-amplitude, in-phase waveguide power divider with the number of output ports equal to the number of horn antenna elements, combines 2^{N} horn antenna elements into a single assembly. Consequently, the number of transmit/receive modules (TRMs) required for the antenna system is reduced by a factor of 2^{N}.

The power divider consists of one input port and 2^{N} output ports, designed from (2^{N}-1) cascaded T-junction branches. The interior of the waveguide power divider features a step-down structure to optimize space for integrating an additional coupling waveguide. The calibration signal in coupling waveguide is extracted from the input of the power divider to continuously monitor the phase and amplitude of each antenna assembly.

The input of the power divider includes a stepped impedance transformer structure that converts the impedance from the coaxial cable to the waveguide, ensuring impedance matching between the antenna assembly and the transmit/receive components.

The power divider consists of 2^{N} output ports with dimensions matched to the input ports of the horn antenna elements, ensuring impedance matching and uniform coupling between the two components. The material used for manufacturing the horn antenna assembly is aluminum treated with a chromate conversion coating, providing a lightweight structure, low transmission loss, and high durability.

For the specific case of N=2, the X-band horn antenna assembly consists of four horn antenna elements, a 1:4 equal-amplitude, in-phase power divider and a coupling waveguide.

The horn antenna element has dimensions of 21.5×18×30 mm³ (broad wall×narrow wall×length), with symmetrical metal ridges in the E-plane measuring 20×1×3 mm³ (length×width×height).

The power divider is an H-plane T-junction divider. The interior of the divider features a step-down structure with a height of 15 mm at the output ports and 10 mm at the input port to ensure sufficient space for integrating a coupling waveguide that extracts the calibration signal from the input. The divider employs a T-junction structure that equally splits the signal into four equal-amplitude and in-phase output ports.

The input port includes a 4 mm-wide stepped impedance transformer structure designed to minimize standing waves and ensure impedance transformation from the coaxial cable of the SMP connector to the waveguide. Inside the input port cavity, there is a coupling slot measuring 6×2 mm², which is used to extract the calibration signal from the antenna assembly input port to the calibration waveguide.

The coupler waveguide is located under the input port cavity of the power divider, with dimensions of 86×20×4 mm³ (length×width×height). The calibration signal passes through a diagonal extraction slot into the coupler waveguide, enabling continuous monitoring of the phase and amplitude of each antenna assembly.

### BRIEF DESCRIPTION OF THE DRAWINGS

FIG. 1 illustrates the structure of the double-ridged horn antenna element.

FIG. 2 shows the return loss S11 of the horn antenna element with and without the metal ridge.

FIG. 3 depicts the structure of the H-plane T-junction waveguide power divider.

FIG. 4 illustrates the structure of the 1:4 waveguide power divider.

FIG. 5 shows the stepped impedance transformer structure at the input port of the 1:4 power divider.

FIG. 6 depicts the return loss S11 of the 1:4 waveguide power divider.

FIG. 7 illustrates the amplitude and phase imbalance of the 1:4 waveguide power divider.

FIG. 8 shows the overall structure of the horn antenna assembly.

FIG. 9 depicts the detailed internal design of the horn antenna assembly.

FIG. 10 shows the active return loss of the antenna assembly in an infinite array during beam scanning in the E-plane.

FIG. 11 illustrates the calibration coupling level of the antenna assembly.

FIG. 12 depicts the radiation patterns of the horn antenna assembly in two planes (E and H-plane).

FIG. 13 shows the antenna array of 16-horn antenna assembly in H-plane.

### DETAILED DESCRIPTION OF THE INVENTION

The invention is described in detail below with reference to the accompanying drawings, which are intended to illustrate the design embodiments of the invention without limiting the scope of the patent protection. Specifically, the horn antenna assembly integrated with a calibration signal comprises the following main components:

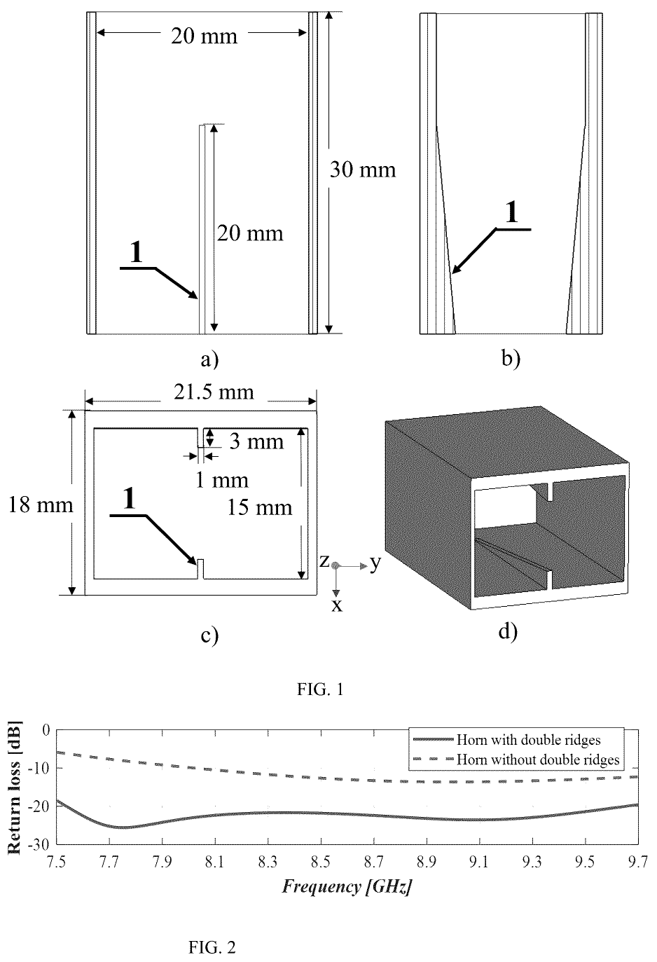

The horn antenna element consists of two symmetrical triangular metal ridges placed in the E-plane, as shown in FIG. 1. The thickness of the metal ridges is 1 mm, which ensures the ridges are resistant to deformation during manufacturing while optimizing the weight of the element. The metal ridges have a right triangular shape with the two perpendicular sides measuring 20×3 mm². The inner aperture dimensions of the horn (broad wall×narrow wall×length) are 20×15×30 mm³. The horn element, with a thickness of 1.5 mm, is made of aluminum treated with chromate to ensure manufacturability and durability.

Referring to FIG. 2, the return loss of the horn element without metal ridges is less than-10 dB only within the frequency range of 8.1 to 9.7 GHZ. With the addition of metal ridges, the return loss of the horn element improves to less than-20 dB over the frequency range of 7.55 to 9.65 GHz. Thus, the antenna bandwidth with metal ridges significantly increases, reaching 24.4%.

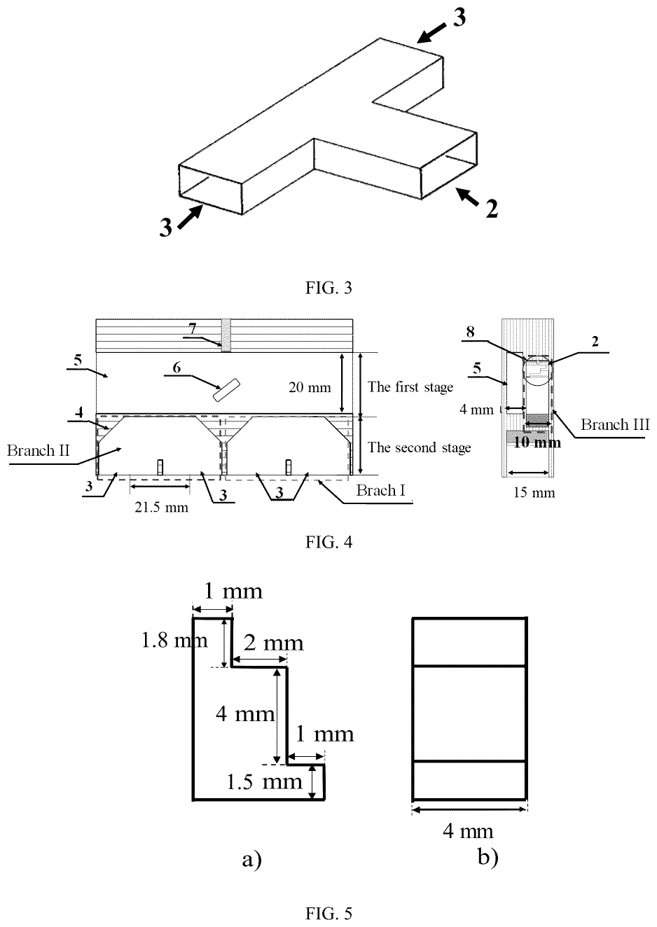

The waveguide power divider is designed based on the T-junction principle on the magnetic field plane (H-plane Tee), consisting of one input port 2 and multiple output ports 3, as shown in FIG. 3. The internal dimensions of the divider's output ports match the internal dimensions of the input ports of the horn antenna elements at the X-band, ensuring impedance matching and uniform connections between the antenna elements and the power divider. The internal width and height dimensions of the output ports of the power divider are 20×15 mm². The waveguide wall thickness is 1.5 mm, ensuring machinability and product durability.

By applying the above methods, a four-element horn antenna assembly can be designed as follows: The horn antenna assembly consists of four horn elements designed as shown in FIG. 1 and one 1:4 power divider.

The proposed divider is a 1:4 equal-amplitude, in-phase waveguide power divider, consisting of one input port 2, referred to as the first port, and four output ports 3, from the second to the fifth port. The structure includes three symmetrical T-junction branches that divide power in the H-plane, as illustrated in FIG. 4. The distance between the output ports 3 of the power divider is 21.5 mm.

The waveguide power divider comprises two stages of power division:
The first stage is a 1:2 divider (Branch III), whose output ports serve as the input ports of the second stage.
The second stage consists of two T-junction dividers (Branches I and II), whose output ports have the same dimensions as the input ports of the horn elements.

45-degree chamfers 4 are applied at the corners of the divider to improve impedance matching.

To provide sufficient space for integrating the calibration signal into the antenna assembly, the first stage divider branch (Branch III) has an internal height of 10 mm, which is lower than the internal height of the second stage divider branches. The calibration waveguide 5, integrated at the location of the first stage divider, has internal dimensions of 20×4 mm² (width×height). Inside the waveguide, a diagonal slot 6 is cut and connected to Branch III to extract the input signal from the power divider as the calibration signal for the horn antenna assembly.

At the input port of Branch III, a stepped impedance transformer structure 8 is employed to ensure impedance matching and to convert energy from the coaxial connector 7 into electromagnetic energy within the waveguide. The step structure consists of three steps, each 4 mm wide. The first step is 1.5 mm high and 1 mm deep; the second step is 4 mm high and 2 mm deep; and the third step is 1.8 mm high and 1 mm deep. The detailed dimensions and geometry of the step structure 8 are shown in FIG. 5.

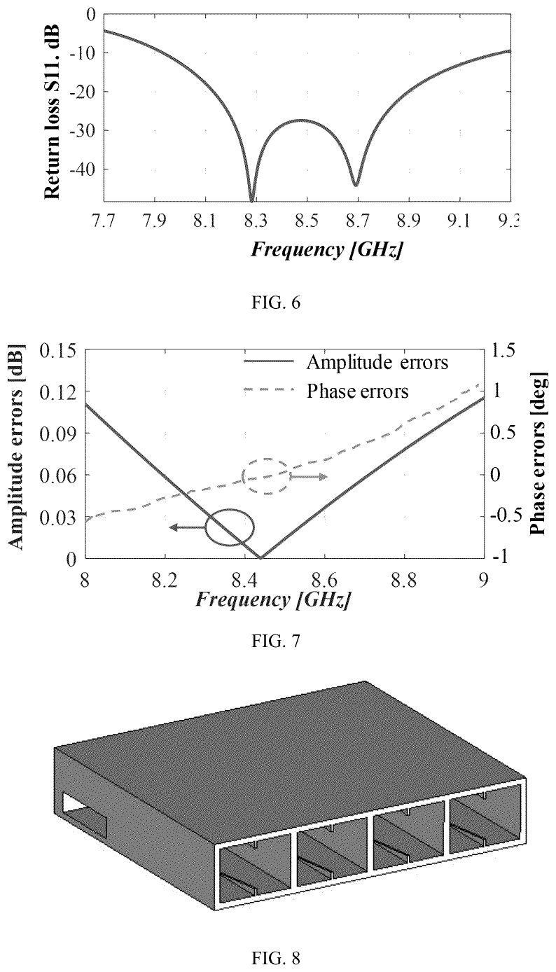

Referring to FIG. 6, the return loss S11 at the input port 2 of the 1:4 power divider is less than-27 dB (equivalent to a voltage standing wave ratio VSWR less than 1.1) over the frequency range from 8.2 to 8.8 GHZ.

The phase and amplitude imbalances among the output ports 3 of the power divider are shown in FIG. 7. It can be observed that the phase imbalance is less than 1.2 degrees and the amplitude imbalance is less than 0.12 dB across the entire frequency band from 8.2 to 8.8 GHz.

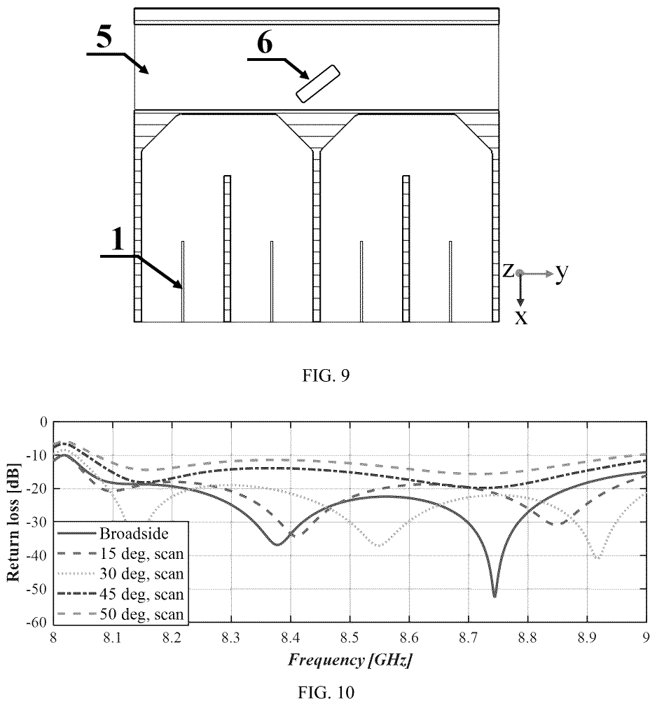

The horn antenna assembly consists of four horn elements and a 1:4 waveguide power divider, with the overall structure shown in FIG. 8. The detailed internal design of the assembly is illustrated in FIG. 9. The assembly has outer dimensions of 86×80×18 mm³ (length×width×height). The materials used for manufacturing the assembly can be copper, aluminum, or alloys. To ensure that the completed assembly is lightweight, has low loss, high radiation efficiency, as well as sufficient rigidity and durability, aluminum treated with chromate is chosen for fabrication.

FIG. 10 illustrates the active return loss (S11) of the horn antenna assembly within an infinite array configuration during E-plane beam scanning. In the in-phase (broadside) condition, the active S11 remains below-22 dB, indicating excellent impedance matching. During beam scanning within a range of up to ±50 degrees, the active return loss S11 remains below-10 dB across the operational bandwidth of approximately 8.2 GHz to 8.8 GHz. This performance indicates that the antenna assembly maintains low reflection and high transmission efficiency over a wide range of scan angles. Importantly, no scan blindness is observed within the ±50° scanning range throughout the entire bandwidth. Scan blindness refers to specific angles and frequencies at which the return loss S11 approaches 0 dB, causing nearly all incident power to be reflected rather than radiated. This effect can lead to performance degradation and potentially damage the transmitter or receiver due to high reflected power. The absence of scan blindness confirms the suitability of the horn antenna assembly for wide angle scanning applications in phased array systems.

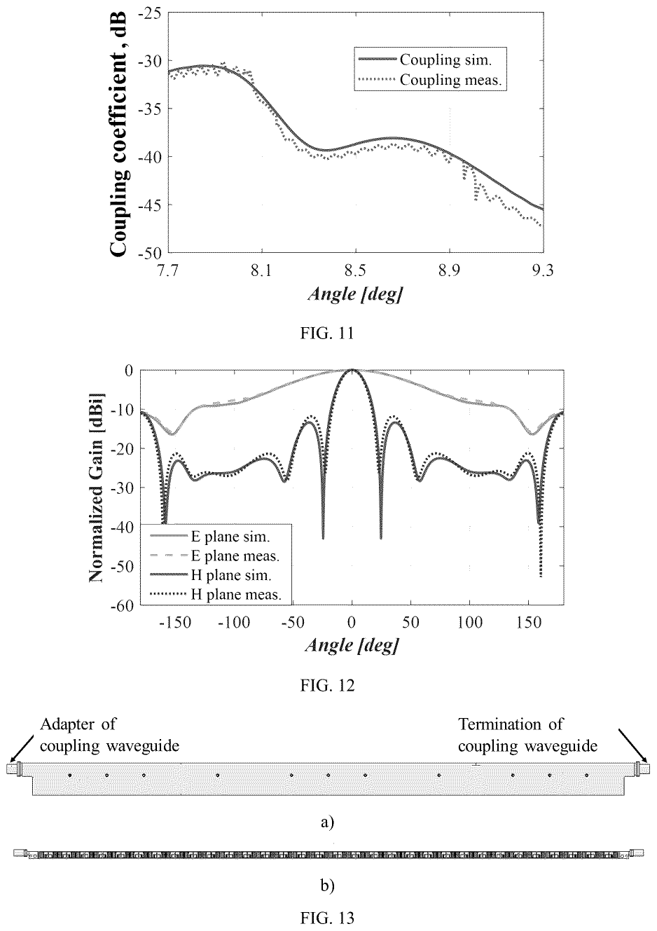

Referring to FIG. 11, the calibration coupling level of the horn antenna assembly achieves-39±1 dB within the frequency band from 8.2 to 8.8 GHz.

The radiation pattern of the horn antenna assembly in the E-plane and H-plane is illustrated in FIG. 12. The assembly achieves a half-power beamwidth of 112 degrees in the E-plane and 20 degrees in the H-plane.

The structure of the horn antenna assembly allows straightforward extension to a two-dimensional antenna array by increasing the number of elements along both the electric field (E-plane) and magnetic field (H-plane) axes.

FIG. 13 depicts a one-dimensional linear antenna array along the H-plane. Eighteen assemblies are arranged in series to form an antenna row with overall dimensions of 1.6×0.08×0.018 m³ (length×width×height). By replicating the number of antenna rows along the orthogonal direction (E-plane), a planar two-dimensional antenna array can be constructed.

The horn antenna array is fabricated through the following steps:
Milling of the top cover;
Milling of the interior of the horn antenna array, which includes the waveguide power divider and the radiating horn elements. To ensure precise alignment with the top cover during assembly, alignment pins are incorporated into the interior design;
Welding the connection between the top cover and the interior of the antenna array. A liquid welding method is used as the mechanical tolerances meet the requirements;
Cleaning the components after fabrication, treating the weld joints, and performing chromate treatment.

### Achieved Effect of the Invention

The design principle of the horn antenna assembly can be broadly applied to antenna systems operating across various frequency bands, including the S-band, X-band, Ku-band, Ka-band.

Specifically, the authors provide a design of a four-element horn antenna assembly for two-dimensional antenna arrays, comprising four horn elements and a 1:4 waveguide power divider. The horn elements are equipped with symmetrical triangular metal ridges in the E-plane, which serve to enhance the operational bandwidth. The waveguide power divider consists of two stages featuring three 1:2 T-junction branches, to achieve equal-amplitude, in-phase power splitting. The divider employs a step-down structure that reduces the internal height of branch III, facilitating the integration of a calibration waveguide for continuous monitoring of the phase and amplitude of each antenna assembly within the system. The power divider demonstrates a low standing wave ratio (≤1.1), minimal phase deviation between output ports (≤) 1.2°, and negligible amplitude imbalance among output ports (≤0.12 dB).

The horn antenna assembly demonstrates a low voltage standing wave ratio (VSWR) within the array, measuring less than 1.17 in the in-phase array configuration and remaining below 2 during beam scanning up to ±50 degrees in the E-plane. Furthermore, no scan blindness is observed within the operating frequency band of 8.2 to 8.8 GHz during beam scanning.

The horn antenna assembly integrated with a calibration signal enables continuous monitoring of the phase and amplitude of each antenna assembly, thereby enhancing the radar system's target detection accuracy.

The horn antenna assembly features a simple structure that enables easy integration and straightforward scaling into a two-dimensional antenna array by increasing the number of elements along the E-plane and H-plane. The array can be precisely fabricated using CNC machining combined with solvent welding. Aluminum treated with chromate is typically used, offering a lightweight and durable structure.

The horn antenna assembly achieves the following key results:

| No. | Parameter | Unit | Result |
|---|---|---|---|
| 1 | Frequency range | GHz | 8.2-8.8 |
| 2 | Voltage standing wave ratio (VSWR) | — | ≤1.17 |
| | in in-phase array | | |
| 3 | Voltage Standing Wave Ratio (VSWR) | — | ≤2 |
| | in beam scanning Array | | |
| 4 | Beam scanning angle in E-plane | degrees (°) | ≤50° |
| 5 | Beam scanning angle in H-plane | degrees (°) | ≤5° |
| 6 | Calibration coupling level | dB | 39 ± 1 |

1. A horn antenna assembly integrated with a calibration signal system, comprising:
2^{N} horn antenna elements, each including symmetrical triangular metal ridges disposed in an E-plane and configured to enhance an operational bandwidth of the horn antenna assembly by providing a gradual impedance transition from an interior of a waveguide to free space; the horn antenna elements are fabricated from aluminum and treated with a chromate conversion coating to improve corrosion resistance and electrical performance;
a waveguide power divider comprising one input port and 2^{N} output ports corresponding to the number of horn antenna elements, the waveguide power divider consisting of (2^{N}-1) T-junction branches configured to evenly distribute power to the horn antenna elements; internal cross-sectional dimensions of the 2^{N} output ports are matched to an input dimensions of the horn antenna elements to ensure impedance continuity; the waveguide power divider is fabricated from aluminum treated with chromate to provide mechanical strength, reduced weight and low transmission loss;
the T-junction branches are arranged within an H-plane to achieve uniform, in-phase power distribution; the waveguide power divider employs a two-stage topology with an internal cross-sectional area of the first stage deliberately reduced relative to the second stage; this design optimization facilitates a more compact form factor, allowing for efficient spatial integration and incorporation of a calibration waveguide to enable continuous phase and amplitude monitoring;
the calibration waveguide includes a diagonal slot etched on the broad wall, which couples with the cavity of the first-stage branch to extract a monitoring calibration signal from the waveguide power divider input port;
the input port of the waveguide power divider includes a stepped impedance transformer structure design to minimize standing waves, facilitate impedance matching between a standard 50-ohm coaxial cable and the 400-500 ohm impedance of the waveguide; the impedance transformer is fabricated from aluminum and can be integrally machined with the power divider body.
